(19) United States
(12) Patent Application Publication
(10) Pub. No.: US 2026/0226225 A1
(43) Pub. Date: Aug. 6, 2026

(54) Epoxy Resins and Methods of Photopolymerizing Resins

(71) Applicants: Keroles Riad, Ottawa (CA); Paula Wood-Adams, Prince George (CA)

(72) Inventors: Keroles Riad, Ottawa (CA); Paula Wood-Adams, Prince George (CA)

(21) Appl. No.: 19/427,101

(22) Filed: Dec. 19, 2025

Related U.S. Application Data
(60) Provisional application No. 63/752,340, filed on Jan. 31, 2025.

(51) Int. Cl. C08G 59/68; C08G 59/24

(52) U.S. Cl. CPC C08G 59/68; C08G 59/24

(57) ABSTRACT

The present invention provides resins and methods of curing resins as may be employed for 3D printing such as an epoxy resin comprising epoxy monomers and quantum dots dispersed throughout. The epoxy resin may include additional non-epoxy monomers capable of polymerizing to epoxy monomers. The epoxy resin is cured through photopolymerization using light in the UVC light range. Photopolymerization using UVC light is also disclosed to polymerize resin monomers independent of quantum dots.

### FIELD OF INVENTION

The present application generally relates to photo-polymerization, and more particularly, relates to the use of UVC light to photo-polymerize resin monomers as well as the design and preparation of a novel epoxy resins comprising quantum dots.

### BACKGROUND OF INVENTION

Photo-polymerization is at the foundation of many industries such as dentistry, coatings, adhesives, and stereolithography 3D printing. Photo-polymerization is preferable to heat-polymerization because light is less unpleasant relative to heat in dentistry applications, easier to apply to precise locations to achieve high printing resolution in circuit board manufacturing and stereolithography, and requires lower energy.

However, the organic cationic photo-initiators currently used are toxic, expensive, and difficult to tune with respect to the wavelength of light required to initiate polymerization reactions. For example, current stereolithography 3D printing resins are unstable under sunlight. The instability of stereolithography epoxy resins and aircraft coatings under sunlight originates from the fact that the absorption wavelength range of commercial photo-initiators overlaps with the solar spectrum on Earth. Existing photo-initiators have some sensitivity to UVA (315-400 nm) and UVB (295-315 nm) which represent 6% of the solar intensity on Earth. These photo-initiators absorb sunlight and further polymerize the material, releasing carcinogenic volatile organic components, and continuously change the material properties to the point of brittle fracture within weeks.

UV absorbers, light stabilizers and inorganic surface coatings are often used to mitigate this instability. However, they only slow down degradation, and like sunscreen on the beach, coatings must be regularly reapplied. On the other hand, the ozone layer blocks light of wavelengths lower than 300 nm, or arguably 310 nm, from the solar spectrum on Earth.

However, there remains a need to control the critical wavelength required to initiate the photo-polymerization reaction and circumvent undesired reactions from taking place outside of controlled conditions.

It would be desirable, thus, to develop an improved method to photo-polymerize resins that may result in polymers that are stable during end use.

### DESCRIPTION OF THE INVENTION

Disclosed herein is an epoxy resin comprising quantum dots dispersed throughout the resin.

In some embodiments, the quantum dots have a crystal size smaller than the Bohr diameter of the quantum dot.

In some embodiments, the quantum dots have a diameter of between 0.1 nm and 50 nm, such as 0.5-20 nm, 1-10 nm, or 2-4 nm.

In another embodiment, the quantum dots have a particle bandgap energy that is above the energy range of natural sunlight, preferably in the Ultraviolet-C (UVC) light energy range. Preferably the bandgap energy is >4.1 eV, more preferably >4.3 eV, and even more preferably >4.5 eV.

In yet another embodiment, the quantum dots have a surface area of greater than 90 m g⁻¹, preferably greater than 200 m² g⁻¹, more preferably greater than 300 m² g⁻¹ or greater than 350 m² g⁻¹ , and may have a surface area of up to about 500 m² g⁻¹ or greater.

In some embodiments, the quantum dots are semiconducting metal quantum dots.

In some embodiments, the semiconducting metal is a metal oxide, a metal sulfide, or a metal selenide.

In some embodiments, the semiconducting metal oxide quantum dots are titania.

In some embodiments, the resin comprises an epoxy monomer such as a glycidyl ether.

In some embodiments, the epoxy resin comprises an acrylate monomer or oligomer; methacrylate monomer or oligomer; and/or thiol monomer or oligomer.

In some embodiments, the epoxy resin comprises additives such as fillers, dyes, pigments, ceramics, and surfactants.

Also disclosed is a method of curing resin. The method comprises mixing at least one epoxy monomer with quantum dots to form a mixture and exposing the mixture to UV light.

In an embodiment, the quantity of quantum dots in the epoxy mixture is about 1-15% wt.

In another embodiment, the epoxy mixture comprises an alcohol in a quantity of about 0-15% wt.

In some embodiments, the amount of monomer in the epoxy mixture is about 60-99% wt.

In some embodiments, the amount of additive in the epoxy mixture is about 0-10% wt.

Also disclosed is a method of curing resin using UVC light. The method comprises mixing monomers to form a resin mixture and curing the resin mixture using UVC light.

In some embodiments, the resin mixture comprises an epoxy monomer and/or oligomer; an acrylate monomer and/or oligomer; a methacrylate monomer and/or oligomer; a thiol monomer and/or oligomer; or combinations thereof.

In other embodiments, the resin mixture comprises at least one photoinitiator.

### BRIEF DESCRIPTION OF THE DRAWINGS

FIG. 1 depicts a TEM image of flame-made silica-embedded TiO₂ quantum dots.

FIG. 2 depicts SEM images of a photo-polymerized film of a mixture containing epoxy, isopropanol (5 wt %), and a) TiO₂ quantum dots or b) P25 titanium.

FIG. 3 shows ¹³C NMR of systems of cyclohexene oxide and isopropanol, wherein (a) is initiator/catalyst free, with no radiation; (b) includes a commercial cationic organic initiator; (c) includes P25 TiO₂ radiated by UVA light; (d) is initiator/catalyst free, radiated by UVA light; (e) includes TiO₂ quantum dots, radiated by UVA light; and (f) includes TiO₂ quantum dots, radiated by UVC light.

FIG. 4 graphically compares epoxy consumption calculated based on the area of the FTIR peak at ~910 cm⁻¹ for epoxy and isopropanol systems with TiO₂ quantum dots a) radiated with UVC light, b) radiated with UVA light, c) without TiO₂ quantum dots radiated with UVC light, and d) is an inset showing a microscope slide blade coated with the resin.

FIG. 5 graphically represents nanoindentation measurements of sample films photo-polymerized with a commercial photo-initiator and TiO₂ quantum dots, where (a) depicts reduced modulus; (b) depicts hardness; and (c) depicts plastic deformation.

### DETAILED DESCRIPTION

In accordance with an aspect of the present invention, an epoxy resin comprising quantum dots dispersed throughout the resin is provided.

An epoxy resin in accordance with the invention comprises a suitable epoxy resin monomer (ERM), either solely or combined with non-epoxy monomers or oligomers such as acrylics including acrylate monomer or oligomer or methacrylate monomer or oligomer, thiol monomer or oligomer, or any other suitable monomer or oligomer for polymerization with epoxy resin monomer. Generally, a suitable epoxy monomer is any monomer or material with an epoxide group. An epoxy monomer may be produced by reaction of epichlorohydrin with a compound having an acidic hydrogen atom from a hydroxy, amine or amide group, to form a glycidyl-based epoxy resin. The hydroxy group may be derived from an aliphatic diol, polyol (e.g. polyether polyol), phenolic compound or a dicarboxylic acid. Examples of suitable epoxy resin monomers include, but are not limited to, bisphenol-based monomers based on epichlorohydrin and a bisphenol such as bisphenol A or bisphenol F to yield a bisphenol diglycidyl ether monomer; novolak-based monomers produced by reacting epichlorohydrin with a novolak (prepared by reacting a phenol with methanal) such as epoxyphenol novolak or epoxycresol novolak monomers; amine-based epoxy resin monomers prepared by reacting epichlorohydrin with an amine, e.g. an aromatic amine; and aliphatic epoxy monomers (glycidyl ethers) formed by the reaction of epichlorohydrin and an aliphatic alcohol or polyol. Other aliphatic epoxy resin monomers include monomers formed by epoxidation of an alkene. For example, cycloaliphatic epoxide resin monomers are formed by epoxidation of a double bond in a ring. This may be accomplished by reaction of a cyclic alkene with a peracid. In another example, an aliphatic epoxide resin monomer is formed by epoxidation of unsaturated fatty acids by reaction with a peracid such as hydrogen peroxide.

Halogenated epoxy resin monomers may be used to impart particular properties on the resulting epoxy resin. For example, brominated epoxy resin monomers may be used to impart flame retardant properties on the resulting resin.

Examples of suitable non-epoxy monomers or oligomers for inclusion in the resin include, but are not limited to, acrylate monomers defined by the formula CH₂═CHCO₂R including monofunctional acrylate monomers such as acrylic acid, methyl acrylate, ethyl acrylate, butyl acrylate, iso-bornyl acrylate, iso-octyl acrylate, 2-hydroxy ethyl acrylate, 2-ethylhexyl acrylate, 2-hydroxy propyl acrylate, and isobornyl methacrylate; multi-functional acrylate monomers such as 1,3-butanediol di-acrylate, zinc di-acrylate, tri-methylol propane triacrylate, ethylene glycol dimethacrylate, tricyclodecane dimethanol diacrylate, tricyclodecane dimethanol dimethyl, ethoxylated bisphenol A dimethylacrylate, neopentyl glycol diacrylate, dipropylene glycol diacrylate, and diethylene glycol diacrylate; acrylate oligomers such as epoxy urethane acrylates, polyurethane acrylate (PUA), epoxy acrylates, aliphatic urethane acrylate, aromatic urethane acrylate, polyester acrylate, and acrylic acrylate; and methacrylate monomers and oligomers such as polyethylene glycol diacrylate (PEGDA), urethane dimethacrylate (UDMA), triethylene glycol dimethacrylate (TEGDMA), bisphenol A-glycidyl methacrylate (Bis-GMA), trimethylolpropane triacrylate (TTA), and bisphenol A ethoxylate diacrylate (Bis-EDA).

Other non-epoxy monomers or oligomers for inclusion in the present resin may include thiol-based compounds. A thiol compound is an organosulfur compound comprising a thiol group, or sulfhydryl group, attached to a carbon atom. The thiol group is a functional group that is made up of the atoms sulfur and hydrogen. Suitable thiol monomers include, but are not limited to, trimethylolpropane tris(3-mercaptopropionate) (TMPMP), pentaerythritol tetra(3-mercaptopropionate) (PETMP), tris[2-(3-mercaptopropionyloxy) ethyl] isocyanurate (TMI), and pentaerythritol tetrakis (3-mercaptopropionate) (PE-1), PE-1 and triallyl-1,3,5-triazine-2,4,6(1H, 3H, 5H)-trione (TTT), 1,4-butandiol dipent- 4-yn-2-yl carbonate (4MPC) and 2,2-bis[4-(2-hydroxy)ethoxyphenyl]propane dibut-3-yn-1-yl carbonate (BABC).

The selected monomers/oligomers for inclusion in the present resin are combined with quantum dots to initiate polymerization. As used herein, the term “quantum dot” refers to a nanoparticle of a material whose crystal size is smaller than the Bohr diameter of the material. In accordance with the invention, nanoparticles in the range of 0.1-50 nm, such as 0.5-20 nm, 1-10 nm or 2-4 nm may be used, however, nanoparticles outside of this range may be used as well. Nanoparticles in this size range exhibit quantum effects, including optical and electronic properties that differ from those of larger particles, such as bandgap tunability and high surface area-to-volume ratios.

The bandgap or energy gap is the energy range in a solid in which no electronic states exist, e.g. the energy difference between the top of the valence band and the bottom of the conduction band. In other words, the bandgap is the energy required to promote an electron from the valence band to the conduction band. The bandgap in quantum dots is readily tuned, e.g. increased or decreased, by changing the size of the quantum dot during synthesis to achieve a desired bandgap energy that results in excitation of an electron from the valence to the conduction band to initiate polymerization reactions. Having a bandgap energy that is above the UV light range of natural sunlight is preferred, e.g. an energy level above 4.1 eV, which is above the energy range of natural sunlight. This allows for a controlled photo-polymerization reaction that will not proceed if the epoxy resin is exposed to sunlight, making the resin photo-stable. Preferably, the bandgap energy is in the UVC light energy range, such as between 4.1-12.4 eV, preferably 4.2-8.4 eV, and more preferably between 4.3-6.4 eV.

Controlling the size of quantum dots during synthesis also allows for very high volume to surface area ratios. As the quantum dots get smaller, the surface area-to-volume ratio increases. Having a surface area greater than the volume of the quantum dot improves the kinetics of the photo-polymerization reaction. As such, having a quantum dot with a high surface area-to-volume ratio is beneficial. Preferably, the surface area of the quantum dots for use to polymerize an epoxy resin is above 90 m² g⁻¹, preferably greater than 200 m² g⁻¹, more preferably greater than 300 m² g⁻¹ or greater than 350 m² g⁻¹, and may have a surface area of up to about 500 m² g⁻¹ or greater.

Quantum dots in accordance with the invention may include, but are not limited to, semiconducting metal quantum dots including metal oxides such as ZnO, TiO₂, SnO₂, and CuO; metal sulfides such as CdS, SnS₂, and MoS₂; or metal selenides such as CdSe, PbSe, and InAs. In accordance with an embodiment, metal oxide quantum dots are preferred. A preferred metal oxide quantum dot is titania (TiO₂).

Semiconducting metal quantum dots can be synthesized using methods known in the art including, for example, colloidal synthesis, plasma synthesis, viral assembly, electrochemical assembly, and flame spray pyrolysis (FSP). FSP is well-established in the art and comprises diluting precursor metals with a solvent (including, but not limited to, xylene. ethanol, and isopropanol), feeding the mixture into an FSP reactor, and atomizing with oxygen. A pilot flame serves as an ignition source and may be in the temperature range of about 500-5000 Kelvins. The metal molecules collide in the flame to form clusters and then nano and/or micro-particles. A nanoparticle size control agent is added to the metal precursor to hinder formation of large crystals and promote the formation of quantum dots. The nanoparticle size control agent can be any amorphous matrix material, such as carbon or preferably, silica. The formed quantum dots may be collected on glass fiber filters placed in a water-cooled stainless-steel holder using a vacuum pump.

To prepare the epoxy resin, the selected resin monomers and/or oligomers are combined with the quantum dots, and optionally alcohol, to form an epoxy resin mixture or solution. The epoxy resin mixture or solution comprises about 1-15% by wt quantum dots, about 0-15% by wt, alcohol and resin monomers/oligomers in an amount of about 70-99% by wt. Any alcohol is suitable for use in the resin mixture. Thus, suitable alcohols include, but are not limited to, primary alcohols, secondary alcohols and tertiary alcohols. Suitable primary alcohols include, but are not limited to, methanol, ethanol, propan-1-ol, and 2-methylpropan-1-ol. Suitable secondary alcohols include, but are not limited to, isopropyl alcohol, 1-phenethyl alcohol, 2-propanol, 2-butanol, cyclobutanol, 2-methylcyclopentanol, propan-1,2-diol, propan-1,2,3-triol, and cyclohexanol. Suitable tertiary alcohols include, but are not limited to, 2-methyl-2-propanol, tert-butyl alcohol, and inositol. Preferred alcohols are isopropyl alcohol, and 1-phenethyl alcohol.

Although alcohols are preferred, any compound with a hydroxyl (—OH) group may be used in the method of making the present resin, including, but not limited to, carboxylic acids, ethers, and particles with surface —OH groups. Examples of suitable carboxylic acids include, but are not limited to, formic acid, propionic acid, acetic acid, butyric acid, and benzoic acid. Examples of suitable ethers include, but are not limited to, ethoxyethane (diethyl ether), methoxyethane (methyl ethyl ether), 2-methoxy-2-methylpropane (MTBE), and phenoxybenzene (diphenyl ether).

In some embodiments, the resin mixture is prepared without alcohol. In such a resin mixture, the mixture contains resin monomers/oligomers and quantum dots.

In some embodiments, the resin mixtures may comprise additives to improve the performance and customize the material properties of the resin, including but not limited to, fillers, dyes, pigments, ceramics, and surfactants. Fillers can be added to the resin mixture to modify the physical characteristics of the cured resin. For example, silica particles can improve tensile and flexural strength, dimensional stability, and thermal resistance. Dyes and pigments may be added to the resin mixture to control the optical properties of the resin, for example darker colors absorb light faster than lighter colors. Ceramics may be added to the resin mixture to improve the mechanical and thermal properties of resins, including zirconia, alumina, and silicon carbide. Surfactants may be added to the resin mixture to reduce the surface tension between the resin and ceramic particles, promoting better contact and adhesion, for example sodium dodecyl sulfate.

The resin mixture, including the monomer/oligomer, quantum dots and optionally alcohol and/or additives, is preferably stirred for a sufficient period of time for the solution to homogenize, which may vary with the resin monomer/oligomer, quantum dots, and optionally alcohol and/or additives used, for example, for 1 to several hours. The resin mixture is then sonicated for a period of time in intervals in order to ensure homogenization occurs. Sonication may be conducted over a period of several minutes to an hour for shorter intervals with rests between each interval.

The sonicated resin mixture is then photo-polymerized by exposure to UV light of an appropriate wavelength, for example, a wavelength that matches the bandgap energy of the quantum dot present in the resin mixture. The semiconducting metal quantum dots oxidize alcohol and produce protons that initiate polymerization. The resin mixture is exposed to UV light with an intensity sufficient to achieve polymerization for a sufficient period of time such as fractions of a second to minutes., which will vary with UV light used and its intensity, as well as the type of resin monomer and other components utilized, and the desired thickness of the resin. In a preferred embodiment, UVC light is used to initiate polymerization.

Prior to polymerization, the resin mixture may be applied to a desired surface through any known technique capable of coating the surface with a layer of the resin mixture between 0.01 mm −100 mm, including blade coating.

In another aspect of the invention, a resin, with or without epoxy monomers, may be prepared without quantum dots and cured using UVC light. In such an embodiment, the resin may comprise the monomers/oligomers, and optionally alcohol or other hydroxy compound and additives as described above. The preparation of the resin mixture includes thoroughly mixing and sonication as described above.

In some embodiments, the resin may comprise at least one photoinitiator. The photoinitiator may be any photoinitiator known in the art or commercially available. Preferably, the photoinitiator is sensitive to light outside of the solar spectrum. Examples of such photoinitiators include, but are not limited to, 2-hydroxy-1-[4-[4-(2-hydroxy-2-methylpropionyl)benzyl)phenyl)-2-methylpropan-1-one, 2-hydroxy-2-methyl-1-phenylpropanone, 1-hydroxycyclohexyl-phenyl ketone, bis(2,6-dimethoxybenzoyl)-2,4,4-trimethylpentylphosphine oxide, 1-[4-(2-hydroxyethoxyl)-phenyl]-2-hydroxy-2-methylpropanone, 2-methyl-1-[4-(methylthio)phenyl]-2-morpholinopropan-1-one, 2,2-dimethoxy-2-phenylacetophenone, 4-phenyl benzophenone, 2,4-diethylthioxanthone, methyl-o-benzoylbenzoate and 2-ethylhexyl-4-dimethylaminobenzoate, or combinations thereof.

The resins of the present invention can be used in any manner in which resins are used depending on the monomers/oligomers used to prepare the resin, including dentistry, coatings, adhesives, and stereolithography 3D printing including printing circuit boards.

The resin of the present invention and methodology used to manufacture said resin provide advantages over the current state of the art. Importantly, in one aspect, quantum dots utilized herein to initiate polymerization are non-toxic and safer than the commonly used organic initiators, which are categorized as substances of very high concern by the European Chemical Agency due to their potential carcinogenic effects. Further, the use of the present quantum dots show improved dispersibility in resin due to their small size, and thereby, achieve the quantum effect. The use of the present quantum dots also result in a resin having significantly better mechanical properties, such as higher reduced modulus and hardness, and less plastic deformation, as compared to resins made with commercially available organic photo-initiators. For example, the present resin exhibits at least a 10% increase in reduced modulus and/or hardness, such as 25%, 50%, 75%, 100% or more, and/or at least a 10% decrease in plastic deformation, such as at least a 25%, 50%, 75% or more decrease, as compared to modulus, hardness and plastic deformation of epoxy films prepared with a commercial organic photo-initiator. In addition, the present resin demonstrates enhanced stability of its mechanical properties in the presence of natural sunlight as compared to epoxy films photo-polymerized with commercially available organic initiators. In addition, resins prepared with photo-initiating quantum dots that are not sensitive to UV light in the UVA and UVB wavelength ranges, i.e. quantum dots having a bandgap energy above the energy of natural sunlight, i.e. that exceeds 4.1 ev, are advantageously photostable.

Embodiments of the invention are described in the following specific examples which are not to be construed as limiting.

### Example 1—Titania Quantum Dot Particle Flame Synthesis

Titania quantum dots were prepared according to an embodiment of the present invention. In particular, titania quantum dots between 2-4 nm with a bandgap energy of 4.3 eV, a surface area of 282 m² g⁻¹, and a mix of anatase and monoclinic crystal structures were prepared.

Materials: titanium (IV) tetraisopropoxide (Sigma-Aldrich, 97%), hexamethyldisiloxane (Sigma-Aldrich, 98.5%), xylene (Sigma-Aldrich, reagent grade).

Synthesis of TiO₂ Quantum Dots: A 0.25 M solution (10 mol% titania with the balance being silica) is prepared by diluting titanium (IV) tetraisopropoxide and hexamethyldisiloxane with about 100 ml of xylene, and fed at 1 mL min⁻¹ through the capillary of the flame synthesis pyrolysis (FSP) reactor and atomized by 3.75 L min⁻¹ of oxygen. The precursor spray is ignited with a pilot flame (1.25 L min⁻¹ of CH₄ premixed with 2.5 L min⁻¹ of O₂). Product nanoparticles are collected on glass fiber filters (Albet-Hahnemühle, GF 6, 25.7 cm diameter) placed in a water-cooled stainless-steel holder with the help of a vacuum pump (Busch, Seco SV 1040 C).

The flame-made TiO₂ quantum dots were characterized using transmission electron microscopy (TEM) via a FEI Tecnai F2 G20 field emission transmission electron microscope, at a 120 kV acceleration voltage. The TiO₂ quantum dots were dispersed in ethanol, and then drop-casted on a carbon coated TEM grid that is left to dry for 30 minutes before imaging.

### Example 2—Epoxy Mixture Preparation and Photo-Polymerization

Mixtures of epoxy resin monomers, alcohol and flame-made TiO₂ (TiO₂), P25 TiO₂ or bis(4-methylphenyl) iodonium hexafluorophosphate were prepared according to an embodiment of the present invention. A control sample was prepared that consisted of only epoxy resin monomers and alcohol.

Materials: flame-made TiO₂, P25 TiO₂ (Sigma Aldrich, >99.5%), commercial organic cationic initiator (bis(4-methylphenyl) iodonium hexafluorophosphate, (Sigma Aldrich, 98%), 1,4-cyclohexane dimethanol diglycidyl ether (mixture of cis and trans, technical grade, (Sigma Aldrich)), and isopropanol (Sigma Aldrich, 99.5%).

Flame-Made TiO₂ Epoxy Mixture Preparation: A 1.5 g mixture containing isopropanol (5 wt %), flame-made TiO₂ (5 wt %), and 1,4-cyclohexane dimethanol diglycidyl ether (the balance) was stirred overnight. The mixture was further sonicated for 30 minutes with a Misonix Sonicator 3000 (5 seconds on, 20 seconds off).

P25 TiO₂ Epoxy Mixture Preparation: A 1.5 g mixture containing isopropanol (5 wt %), P25 TiO₂ (5 wt %), and 1,4-cyclohexane dimethanol diglycidyl ether (the balance) was stirred overnight. The mixture was further sonicated for 30 minutes with a Misonix Sonicator 3000 (5 seconds on, 20 seconds off).

Commercial Organic Cationic Initiator Epoxy Mixture Preparation: A 1.5 g mixture containing isopropanol (5 wt %), bis(4-methylphenyl) iodonium hexafluorophosphate (5 wt %), and 1,4-cyclohexane dimethanol diglycidyl ether (the balance) was stirred overnight. The mixture was further sonicated for 30 minutes with a Misonix Sonicator 3000 (5 seconds on, 20 seconds off).

Control Epoxy Mixture Preparation: A 1.5 g mixture containing isopropanol (5 wt %) and 1,4-cyclohexane dimethanol diglycidyl ether (the balance) was stirred overnight. The mixture was further sonicated for 30 minutes with a Misonix Sonicator 3000 (5 seconds on, 20 seconds off).

Photo-polymerization: Each of the four epoxy mixtures were radiated under ambient conditions, no inert gas used, with UVA and UVC using a UVP (CL-1000L) crosslinker with a peak emission at 365 nm, and a UVP (CL-1000) crosslinker with a peak emission at 254 nm, respectively. Both crosslinkers had a light intensity of 4 mW cm⁻² at the surface of the samples. The UVA crosslinker has a broad emission spectrum that spans from ~310 nm to ~435 nm. That broad emission spectrum of the UVA crosslinker overlaps with a portion of the UVB region, and almost perfectly matches the UV range present in sunlight on Earth. As such, the two UV crosslinkers selected in this work properly support the objective of this study: developing photocatalysts that are stable under sunlight during end use.

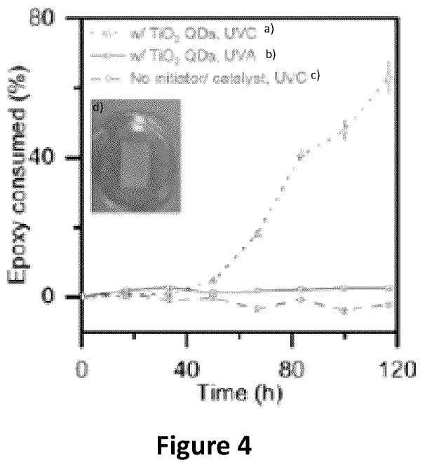

Mixtures prepared for ¹³C NMR were photo-polymerized by being radiated for 50 hours in all cases. Mixtures were blade coated on microscope slides (example shown in the inset (d)) of FIG. 4) with 0.0635 cm thick Kapton tape (McMaster-Carr) for FTIR spectroscopy, and on AFM metal desks for nanoindentation measurements. Nanoindentation films with titania quantum dots and commercial photo-initiators were photo-polymerized by being radiated for 3 hours in the UVA crosslinker, and 133 hours in the UVC crosslinkers respectively.

Scanning electron microscopy (SEM) imaging was conducted on the same films used for nanoindentation that experienced 500 hours of UVA exposure. A Hitachi S-3400N microscope was used at 30 Pa variable pressure and 15 kV.

Monitoring of the epoxy photo-polymerization chemical reaction: The epoxy photo-polymerization chemical reaction was monitored via ¹³C nanomagnetic resonance spectroscopy (NMR) and Fourier transform infrared (FTIR) spectroscopy.

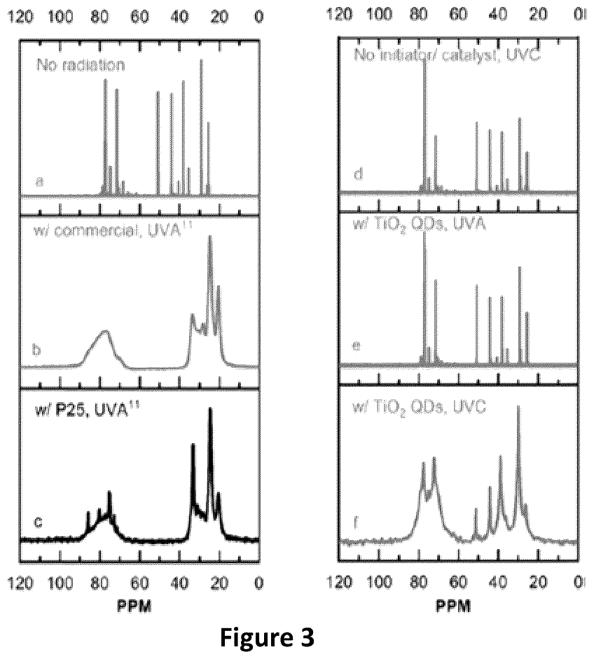

Liquid-state ¹³C NMR experiments were conducted on samples showing no polymerization (FIG. 3a, d and e), while solid-state NMR experiments were conducted on the other mixtures that have polymerized, as assessed by a typical physical change from liquid to a “paste-like” state. Liquid-state spectra were recorded on a Bruker Avance III HD spectrometer operating at a field of 14.1 T with corresponding ¹³C and ¹H Larmor frequencies of 150.87 and 599.99 MHz respectively, using a double resonance BBFO probe. ¹³C spectra of the soluble samples were acquired with NOE enhancement during the recycle delays. 16 384 transients were added with 1 s acquisition time a spectral width of 234 ppm and a recycle delay of 2 s. The ¹³C spectra of the solid samples were obtained on a Bruker Avance III HD spectrometer operating at a field of 9.4 T with corresponding ¹³C and ¹H Larmor frequencies of 100.6 and 400.1 MHz respectively. A 4 mm double resonance probe was used operating at room temperature and a magic-angle spinning frequency of 12.5 kHz using a 2 ms long 30% ramped ¹H to ¹³C cross polarization. A 50 kHz spectral width was used and 4096 transients were added with 15 ms acquisition time and a recycle delay of 5 s. High-power ¹H decoupling was applied during the acquisition using SPINAL-64. The applied radio-frequency fields were 75 kHz and 85 kHz for ¹³C (cross-polarization) and ¹H (cross-polarization and decoupling). All spectra were externally referenced to TMS (0 ppm) by setting the unshielded CH₂ resonance of adamantane to 38.48 ppm.

FTIR spectroscopy was conducted using ThermoFisher's Nicolet IS10 spectrometer in ATR mode with 64 scans at 1 cm⁻¹ resolution between 600 cm⁻¹ and 4000 cm⁻¹.

Monitoring of the mechanical properties of the photo-polymerized epoxy films: Nanoindentation was used to provide thin film mechanical properties. A Hysitron Triboindenter TI 950 (Bruker) was used to conduct indents using a 25 μN load which was held for 5 seconds with loading and unloading times also being set to 5 seconds each. This process was repeated for 25 indents in a 5×5 matrix for each sample. The method of Cheng and Cheng was used to calculate the reduced modulus, briefly the epoxy resin is indented and the reduced modulus is calculated using the initial unloading slope, contact depth, and instantaneous relaxation modulus. Hardness was calculated as the load over the projected area at the beginning of the hold period. Plastic deformation was measured as the residual depth at the end of the unloading cycle.

### Results

Metal oxide quantum dots were synthesized in flame by adding silica, which hinders the growth of the metal oxide crystal allowing for the very small crystal sizes necessary to achieve the quantum effect. Herein, nanoparticles composed of 10% TiO₂ and 90% silica were used that were sized between 2-4 nm. These quantum dots exhibit a bandgap energy of 4.3 eV (UVC region), which is higher than the 4.1 eV upper limit of sunlight on Earth; a surface area of 282 m²g⁻¹ ; a d(BET) of 9 nm; and a mix of anatase and monoclinic crystal structures.

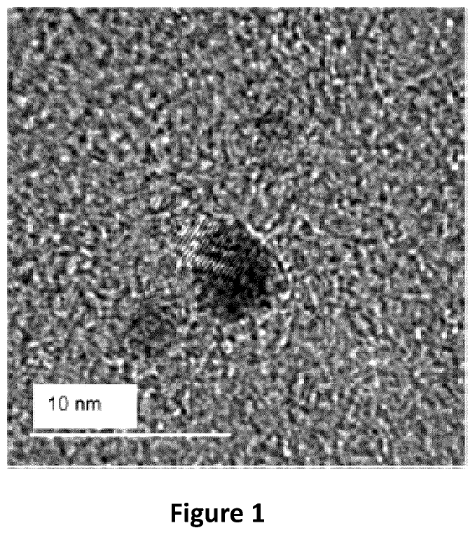

Characterization of TiO2 Quantum Dots: FIG. 1 shows a TEM image of the TiO₂ quantum dots synthesized according to the FSP method. The TEM image shows two titania crystals embedded in an amorphous silica matrix. The two crystals have sizes in the range between 2-4 nm. It is important to note the TEM imaging is biased towards larger crystals as they are much easier to locate, especially in this case where the titania content constitutes only 10 wt % with the balance being an amorphous silica matrix. The morphology of the flame-made titania particles is a mixed phase where the quantum-sized titania crystals are embedded in a silica matrix, not a core-shell structure. This mixed phase structure has been found to improve dispersibility and catalytic performance, while a core-shell structure eliminates surface catalytic reactions.

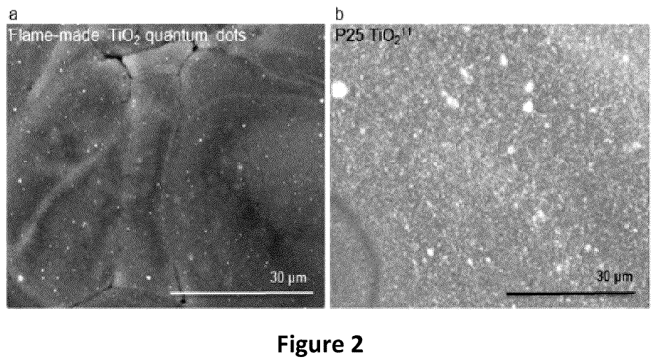

Dispersibility of Quantum Dots: FIG. 2a shows an SEM image of the photo-polymerized films containing TiO₂ quantum dots, demonstrating much better dispersibility relative to P25 TiO₂ shown in FIG. 2b. The improved dispersibility can be assessed by the absence of the large titania agglomerates in FIG. 2a, how well spread out the quantum dots are, and how much smaller they are compared to the P25 TiO₂ which is shown in FIG. 2b. The improved dispersibility is due to the silica matrix in which the flame-made TiO₂ quantum dots are embedded.

Photo-Polymerization Under UVC Light: FIG. 3 shows ¹³C NMR results. The shift at 51.7 ppm seen in FIG. 3a corresponds to epoxide rings in the unpolymerized monomer. The methylene carbons at 20-33 ppm, and methine carbons at 68-90 ppm in FIGS. 3b and 3c expected for polymerized epoxy, overlap with shifts present in the initial monomer in the same region as shown in FIG. 3a. As such, the broadening of those shifts due to the increase in molecular weight that takes place seen in FIGS. 3b and 3c are indicative of epoxy photo-polymerization. FIG. 3d shows the liquid-state ¹³C NMR spectra of a control system with neither photo-initiators nor photocatalysts, radiated by UVC light. No broadening is observed in the spectrum shown in FIG. 3d, which is also almost identical to that of the unpolymerized epoxy monomers shown in FIG. 3a, demonstrating that UVC radiation does not photo-polymerize epoxy in the absence of a photo-initiator or a photo-catalyst. FIGS. 3e and 3f show the solid-state ¹³C NMR spectra of epoxy systems containing the titania quantum dots radiated by UVA and UVC, respectively. The spectrum shown in FIG. 3e for the epoxy system containing titania quantum dots and radiated by UVA is also identical to that of the unpolymerized epoxy monomers shown in FIG. 3a and no peak broadening is observed. This demonstrates that UVA radiation does not initiate the quantum dots to catalyze the epoxy photo-polymerization reaction. The shift at 51.7 ppm, corresponding to unpolymerized epoxide rings, still appears in the spectrum shown in FIG. 3f, suggesting that the film in not fully polymerized. Nonetheless, the shape of the spectrum shown in FIG. 3f of the epoxy system with the TiO₂ quantum dots radiated by UVC is very similar to that of the epoxy system photo-polymerization by P25 titania in FIG. 3c, with significant broadening in the observed shifts. This demonstrates that UVC radiation does indeed initiate the titania quantum dots to catalyze the epoxy photo-polymerization reaction.

Reaction Kinetics of Photo-Polymerization: FIG. 4 shows reaction kinetics by following the consumption of epoxide groups via the Fourier Transform Infrared Spectroscopy (FTIR) peak at 910 cm⁻¹ , normalized relative to the aliphatic peak area (2800-3000 cm−1). No epoxy consuming reaction is detected in the control sample with neither a photo-initiator nor a photo-catalyst after prolonged exposure to UVC light (dashed line with circles). Similarly, no epoxy consuming reaction is detected in the control sample with the TiO₂ quantum dots after prolonged exposure to UVA light (solid line with squares). However, there is a typical photo-polymerization pattern in the samples with TiO₂ quantum dots when exposed to UVC light (dotted line with triangles). The FTIR findings in FIG. 4 that demonstrate that the TiO₂ quantum dots are excited to catalyze the photo-polymerization of epoxy with UVC but not UVA light is consistent with ¹³C NMR data shown in FIG. 3. Further, the epoxy films photo-polymerized with titania quantum dots (only 10 wt % of the TiO₂ active catalyst) reach maximum epoxy consumption after 116 hours, 20% faster than the 150 hours it took those photo-polymerized with P25 titania (100 wt % of the TiO₂ active catalyst), the gold standard for photocatalytic activity. This improved kinetic performance is likely due to the higher surface area of the titania quantum dots (282 m² g⁻¹) as compared to that of P25 (50 m² g⁻¹), as well as interactions between the anatase and the monoclinic crystal structures present in flame-made titania. Finally, the epoxy films photo-polymerized with titania quantum dots show a substantial degree of polymerization. The maximum possible degree of polymerization in cross-linked thermosets depends on many factors including steric hindrance, degree of side reactions and monomer geometry. Nonetheless, the degree of polymerization of the epoxy films photo-polymerized with TiO₂ quantum dots shown in FIG. 4 exceeds the 33% gelation threshold estimated based on Flory theory. Note that in the case of photo-polymerization reactions, the epoxy monomer used here is considered to have four functional groups.

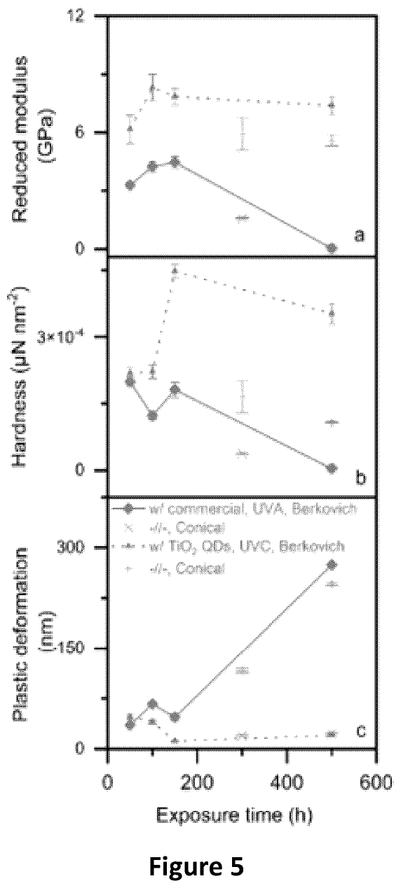

Monitoring of the mechanical properties of the photo-polymerized epoxy films: FIG. 5 shows the mechanical properties of the photo-polymerized epoxy films as measured by nanoindentation: reduced modulus (FIG. 5a), hardness (FIG. 5b) and plastic deformation (FIG. 5c). The epoxy films photo-polymerized with titania quantum dots are shown as dotted lines with triangles, while those photo-polymerized with a commercial initiator are shown as solid lines with diamonds. The data depicted using lines are obtained using a Berkovich tip, as is best practice. However, spot checks were also conducted on two specimens, depicted using points (×for commercial, +for TiO₂ QDs), with a conical tip to assess the effect of tip geometry. In all the measured mechanical properties, the trend is the same with both tips. However, the values obtained using a conical tip are always lower in the cases of reduced modulus and hardness, and higher in the case of plastic deformation, relative to those obtained using the Berkovich tip.

Slight changes were observed in local mechanical properties (FIG. 5) of both films over the first 150 hours of post-polymerization UVA exposure. The only substantial change in this period is the hardness (FIG. 5b) of the epoxy films photo-polymerized with titania quantum dots.

In all three cases, it is observed that the epoxy films photo-polymerized with the titania quantum dots exhibit significantly better mechanical properties (higher reduced modulus and hardness, and less plastic deformation), than those of the films photo-polymerized with a commercial organic photo-initiator. In fact, at the 150 hours of UVA exposure mark, the epoxy films photo-polymerized with the titania quantum dots showed double the reduced modulus and hardness, and 75% less plastic deformation relative to those of the films photo-polymerized with a commercial organic photo-initiator.

The mechanical properties of the epoxy films photo-polymerized with a commercial organic photo-initiator drastically deteriorated after 300 hours of exposure to UVA. Indeed, in the case of the epoxy films photo-polymerized with such organic photo-initiator, both the reduced modulus (FIG. 5a) and hardness (FIG. 5b) dropped to near zero, and plastic deformation (FIG. 5c) increased by an order of magnitude.

On the other hand, and most importantly, the mechanical properties of the epoxy films photo-polymerized with titania quantum dots remained stable for the 500 hours of UVA exposure that were tested. This indicates that UVA light, and in turn, sunlight, has no effect on the mechanical properties of the epoxy films photo-polymerized with titania quantum dots having a bandgap energy higher than the 4.1 eV threshold of the Solar spectrum on Earth.

Conclusion: It is herein demonstrated that quantum dots with a bandgap energy of greater than UVA light can catalyze epoxy photo-polymerization when radiated with UVC light, while being insensitive to UVA light, leading to products that are both stronger and photo-stable during end-use.

1. An epoxy resin comprising quantum dots of a material dispersed throughout.

2. The epoxy resin according to claim 1, wherein the quantum dots have a crystal size that is smaller than the Bohr diameter of the material.

3. The epoxy resin according to claim 1, wherein the quantum dots have a diameter range of between 0.1 nm and 50 nm, such as 0.5-20 nm, 1-10 nm, or 2-4 nm.

4. The epoxy resin according to claim 1, wherein the quantum dot is a semiconducting metal quantum dot.

5. The epoxy resin according to claim 4, wherein the semiconducting metal quantum dot is a metal oxide quantum dot, a metal sulfide quantum dot, or a metal selenide quantum dot.

6. The epoxy resin according to claim 4, wherein the semiconducting metal quantum dots have a particle bandgap energy that is above 4.1 eV, such as >4.3 eV, or >4.5 eV.

7. The epoxy resin according to claim 4, wherein the semiconducting metal quantum dots have a particle bandgap energy that is in the Ultraviolet-C (UVC) light energy range.

8. The epoxy resin according to claim 4, wherein the semiconducting metal quantum dots have a surface area >90 m² g⁻¹, such as >200 m² g⁻¹, >300 m² g⁻¹, or >350 m² g⁻¹, or up to about 500 m² g⁻¹ or greater.

9. The epoxy resin according to claim 4, wherein the semiconducting metal quantum dot is a metal oxide.

10. The epoxy resin according to claim 9, wherein the metal oxide is titania.

11. The epoxy resin according to claim 1, wherein the epoxy resin comprises at least one epoxy monomer.

12. The epoxy resin according to claim 11, wherein the at least one epoxy monomer is a glycidyl ether epoxy monomer.

13. The epoxy resin according to claim 11, wherein the at least one epoxy monomer is 1, 4-cyclohexane dimethanol diglycidyl ether.

14. The epoxy resin according to claim 1, wherein the epoxy resin further comprises acrylate monomers and/or oligomers; methacrylate monomers and/or oligomer, thiol monomers and/or oligomers, or combinations thereof.

15. The epoxy resin according to claim 14, wherein the acrylate monomers are selected from acrylic acid, methyl acrylate, ethyl acrylate, butyl acrylate, iso-bornyl acrylate, iso-octyl acrylate, 2-hydroxy ethyl acrylate, 2-ethylhexyl acrylate, 2-hydroxy propyl acrylate, and isobornyl methacrylate, 1,3-butanediol di-acrylate, zinc di-acrylate, tri-methylol propane triacrylate, ethylene glycol dimethacrylate, tricyclodecane dimethanol diacrylate, tricyclodecane dimethanol dimethyl, ethoxylated bisphenol A dimethylacrylate, neopentyl glycol diacrylate, dipropylene glycol diacrylate, and diethylene glycol diacrylate;
the acrylate oligomers are selected from epoxy urethane acrylates, polyurethane acrylate (PUA), epoxy acrylates, aliphatic urethane acrylate, aromatic urethane acrylate, polyester acrylate, and acrylic acrylate;
the methacrylate monomers or oligomers are selected from polyethylene glycol diacrylate (PEGDA), urethane dimethacrylate (UDMA), triethylene glycol dimethacrylate (TEGDMA), bisphenol A-glycidyl methacrylate (Bis-GMA), trimethylolpropane triacrylate (TTA), and bisphenol A ethoxylate diacrylate (Bis-EDA); or
the thiol monomers or oligomers are selected from trimethylolpropane tris(3-mercaptopropionate) (TMPMP), pentaerythritol tetra(3-mercaptopropionate) (PETMP), tris[2-(3-mercaptopropionyloxy) ethyl] isocyanurate (TMI), and pentaerythritol tetrakis (3-mercaptopropionate) (PE-1), PE-1 and triallyl-1,3,5-triazine-2,4,6(1H,3H,5H)-trione (TTT), 1,4-butandiol dipent-4-yn-2-yl carbonate (4MPC) and 2,2-bis[4-(2-hydroxy)ethoxyphenyl]propane dibut-3-yn-1-yl carbonate (BABC).

16. The epoxy resin according to claim 1, wherein the resin comprises an additive selected from fillers, dyes, pigments, ceramics, and surfactants.

17. The epoxy resin according to claim 1, wherein the amount of quantum dots in the epoxy resin is about 1-15 wt %; the amount of alcohol in the epoxy resin mixture is about 0-15 wt %; the amount of monomer in the epoxy resin mixture is about 60-99% wt; and the amount of additive in the epoxy resin mixture is 0 -10 wt %.

18. A method of preparing an epoxy resin, the method comprising:
combining at least epoxy monomer with quantum dots to form an epoxy resin mixture; and
curing the epoxy resin mixture using UV light.

19. The method according to claim 18, wherein the UV light is UVC light.

20. A method of curing a resin comprising:
mixing monomers to form a resin mixture; and
curing the resin mixture with UVC light.
